(19) United States
(12) Patent Application Publication
(10) Pub. No.: US 2010/0326794 A1
(43) Pub. Date: Dec. 30, 2010

(54) Modular Conveying Plant

(75) Inventor: Daniele Manzon, Rozzano (IT)

Correspondence Address: WILLIAM J. SAPONE;COLEMAN SUDOL SAPONE P.C., 714 COLORADO AVENUE, BRIDGE PORT, CT, 06605, US

(73) Assignee: CARLE & MONTANARI S.P.A., Rozzano (Milano) (IT)

(21) Appl. No.: 12/867,549

(22) PCT Filed: Mar. 12, 2009
(86) PCT No.: PCT/EP09/52952

§ 371 Date: Aug. 13, 2010

(30) Foreign Application Priority Data
Mar. 14, 2008 (IT) BO2008A000165

(51) Int. Cl. B65G 47/57

(52) U.S. Cl. 198/463.3

(57) ABSTRACT

Modular conveying plant for elements or containers, comprises at least a conveyor (2, 3) provided with respective upper transport lines (4, 5) separated in two portions by an interchangeable intermediate module (30, 50, 70) where this intermediate module includes at least one among the continuation intermediate module (30), the intermediate module of lateral deviation (50), the intermediate module of bi-directional lateral exchange (70).

### TECHNICAL FIELD

The present invention refers to plants for conveying semi-finished products which are made in industrial environments and particularly refers to a modular conveying plant especially suitable for carrying out moulds or trays for foodstuffs or for similar products.

### BACKGROUND ART

There are known conveying devices intended to connect in series two equipments for bringing products, moulds or trays from one to another.

Such known devices, generally belt or chain units, can have two overlapped and parallel lines used for example, one for conveying moulds containing products from a moulding machine to an unmoulding machine and the other for bringing back the empty moulds to the moulding machine.

A disadvantage of these known conveying devices consists in that they allow limited configurations almost exclusively point to point connections so resulting rigid and unsuitable to changes of the industrial plant to which they are applied. For example, if one wishes to insert an intermediate station between two pre-existing working stations connected by a conveyor of known type, it is necessary not only to replace the conveyor but also to move away the two original workstations to make place to that intermediate.

Similarly, if one wishes to modify the product flow to be worked among pre-existing stations, it is necessary to make complicated, slow and expensive operations for changing the conveyors connecting said stations.

### DISCLOSURE OF THE INVENTION

An object of this invention is to propose a modular conveying plant that permits to insert additional workstations in a pre existing plant in a simple, fast and cheap way, without displacing or modifying the pre-existing stations.

Another object is to allow a simple, fast and inexpensive change of product flow or path in a pre-existing plant.

### BRIEF DESCRIPTION OF THE DRAWINGS

The characteristics of the invention are highlighted in the following with particular reference to the attached drawings, in which:

FIG. 1 shows a partial top view of a possible configuration of modular conveying plant object of the present invention;

FIG. 2 shows a schematic vertical section view of the plant of FIG. 1;

FIG. 3 shows a partial and plan view of a conveyor of the modular conveying plant object of the present invention;

FIG. 4 shows a schematic vertical section view of the conveyor of FIG. 3;

FIGS. 5 and 6 show top and not in scale views of respective configurations of the modular conveying plant object of the present invention.

### BEST MODE OF CARRYING OUT THE INVENTION

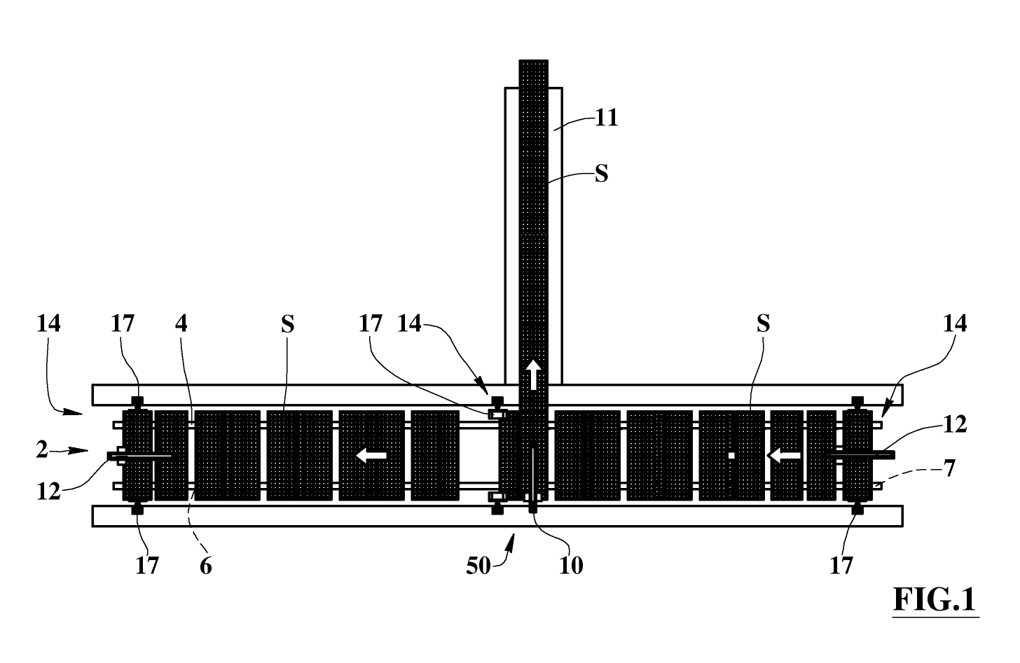

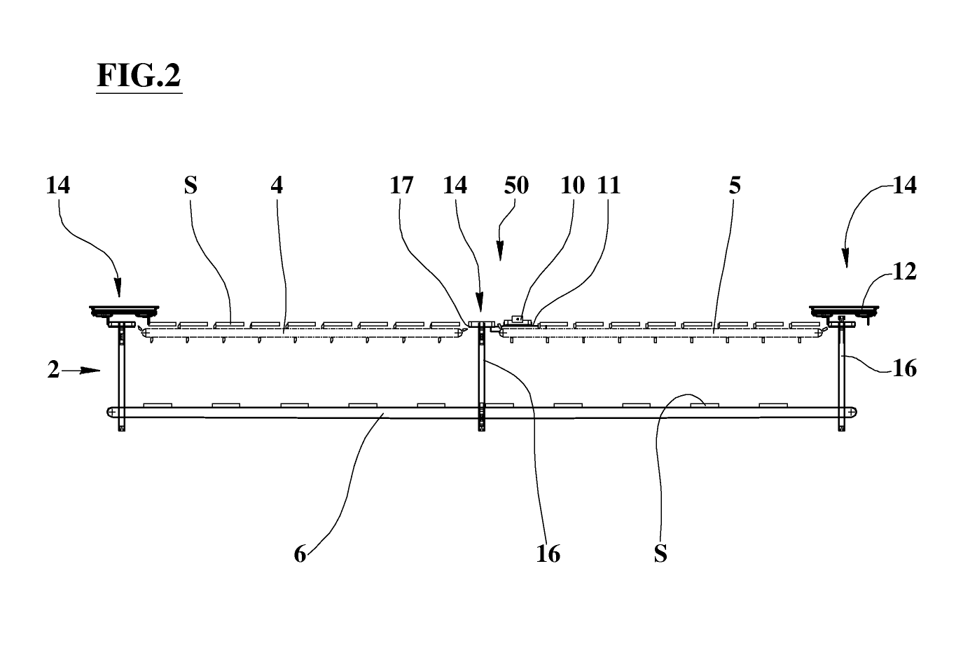

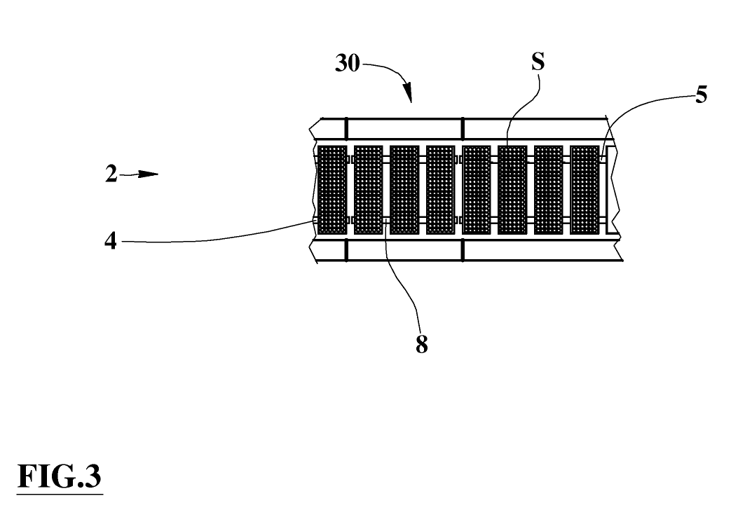

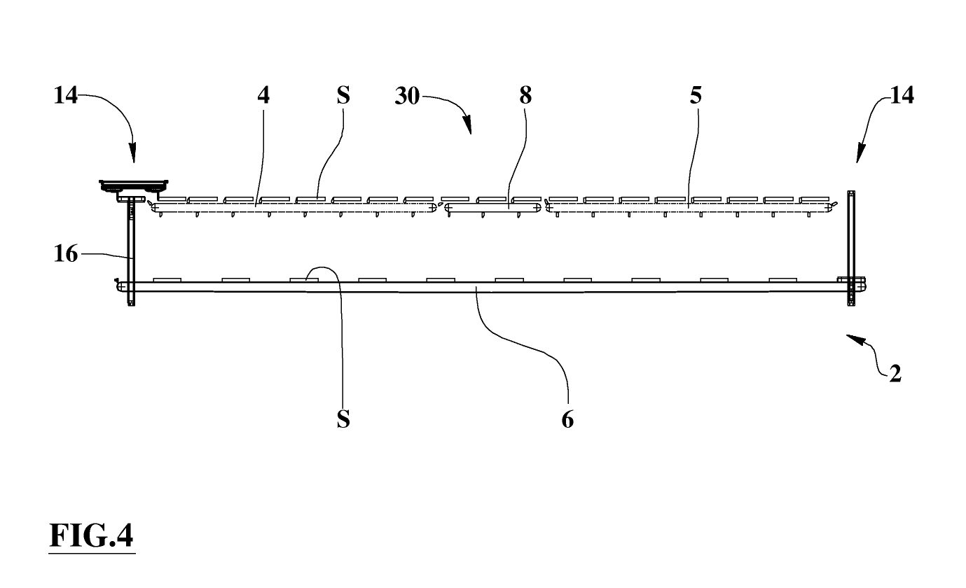

With reference to FIGS. 1-4, numeral 1 indicates the plant object of the present invention comprising a plurality of conveyers 2, 3 equipped with respective upper transport lines 4, 5 and desirable lower transport lines 6, 7 which are parallel and below the upper lines 4, 5.

This plant is intended for conveying, for example among machines, stores and stations of elements or containers S that, by way only of example, can be made up by moulds with recess for foodstuffs which moves full and in going on the upper transport lines 4, 5 and empty in return, on the lower transport lines 6, 7. It is however provided that the full and empty moulds may pass from the upper transport lines 4, 5 to the lower lines 6, 7.

The transport lines 4, 5, 6, 7 are, for example, belt, chain, or with single chain or with parallel chains and can be equipped with projections or pushers to match with elements or containers S pushing them and keeping their correct position.

The transport lines 4, 5, 6, 7 can be separated in two portions by an interchangeable intermediate module 30, 50, 70.

This interchangeable intermediate module consists of a continuation intermediate module 30, by an intermediate module of lateral deviation 50 or by an intermediate module of bi-directional lateral exchange 70.

The invention provides that the plant could be made, on its setup, by all the elements needed for the end configuration that, however, will be modifiable by replacement of the modular elements. In alternative the initial plant, for example of the type with a single conveyor 2 for the transport of elements or containers S between two stations such as an oven or moulding machine and a unmoulding machine, can be provided with one or more continuation intermediate modules 30 for preparing the plant for a simple and fast implementation by means of other modules and possibly additional elements.

Each continuation intermediate module 30 includes an upper transport portion 8, for example of the same type of the upper transport lines 4, 5.

In the assembly condition of the continuation intermediate module 4, the upper transport portion 8 is coplanar and adjacent to ends of the same upper transport lines 4, 5, to allow the passage of the elements or containers from an upper transport line 4, 5 to another 5, 4 of the conveyor 2, 3.

Optionally one or more continuation intermediate modules 30 can be equipped with a lower transport portion coplanar and adjacent to ends of the lower transport lines 6, 7. In the assembly condition of the continuation intermediate module 4, the lower transport portion is aligned to the corresponding lower transport lines 6, 7 to allow the passage of the elements or containers between them.

Each intermediate module of lateral deviation 50 comprises at least a first respective linear transverse actuator 10, for example an electrical actuator or a pneumatic or hydraulic cylinder or similar with the movable end that translates, perpendicularly to the direction of the motion, the elements or containers and provided with a backing pusher with the same elements or containers.

This transverse linear actuator 10 is therefore assigned to translate the elements or the containers from one of the transport lines 4, 5 of the conveyor to a first respective sliding plane or lateral conveyor 11 orthogonally oriented with respect to the conveyor 2, 3 having the same intermediate module of lateral deviation 50. The element or container advancement on the first lateral sliding plane 11 occurs by reciprocal transmission of the push supplied by the first linear transverse actuator 10 that has a fixed or adjustable stroke, corresponding to the dimension of the elements or transverse containers S as regard to the conveyor 2, 3.

Each intermediate module of bi-directional lateral exchange 70 comprises at least one respective first linear transverse actuator 10, for example equal to that of the intermediate module of lateral deviation 50, intended to translate the elements or containers from one of the transport lines 4, 5 to a respective first sliding plane or lateral conveyor 11 orthogonally oriented as respect to the conveyor 2, 3 of the intermediate module of lateral bi-directional exchange 70.

This bi-directional module 70 includes moreover a lateral entry sector 15, for example chute or ramp type supplied by a respective second sliding plane or lateral conveyor 13, parallel to the first conveyor 11. The lateral entry sector 15 is intended for sliding or translation, without jamming, of the elements or containers from said second plane or lateral conveyor 13 to one of the transport lines 4, 5.

The planes or lateral conveyers first 11 and second 13 can be equal and in particular can be made of planes, plates or almost horizontal panels made or covered with low friction coefficient material.

In the conveyers with two transport planes, the intermediate modules of lateral deviation 50 and the intermediate modules of bi-directional lateral exchange 70, each can comprise a first respective linear transverse actuator 10 for upper transport lines 4, 5 and/or at least one respective optional linear transverse actuator 10 for lower transport lines 6, 7.

Each transverse linear actuator 10 is associated with a first respective sliding plane or lateral conveyor 11.

In the conveyers with two transport planes, the bi-directional lateral exchange module 70 comprises at least one lateral entry sector 15, supplied by a second respective sliding plane or lateral conveyor 13, for the upper transport lines 4, 5 and/or an optional lateral entry sector 15 for lower transport lines 6, 7.

The plant can moreover comprises vertical transfer means 14 intended to translate the elements or containers from a lower transport line 6, 7 to an upper transport line 4, 5 of the same conveyor 2, 3 or vice-versa.

Each vertical transfer means 14 includes a vertical linear actuator 16, for example of electromechanical, electrical, pneumatic or hydraulic type, provided with a couple of shelf means 17 faced and intended to match from bottom with the lateral portions of the elements or containers S of an upper transport line 4, 5 and to deposit such elements on a lower transport line 6, 7.

The vertical transfer means 14 intended to convey the container elements S also from bottom to top, that is from a lower transport line 6, 7 to an upper transport line 4, 5, they are also equipped with a respective longitudinal linear actuator 12, associated to the upper destination transport line 4, 5 to transfer elements or containers from shelf means 17 to said destination transport line 4, 5. The longitudinal linear actuators 12 can be similar or equal to the linear transverse actuators 10 but differ from these latter because they operate on the elements or containers S in longitudinal direction or parallel to the motion direction of the elements or containers S on the transport lines and can differ for the stroke length that they impress to elements or to containers S.

One or more of the intermediate modules of lateral deviation 50 and of bi-directional lateral exchange 70 can comprise one of the vertical transfer means 14.

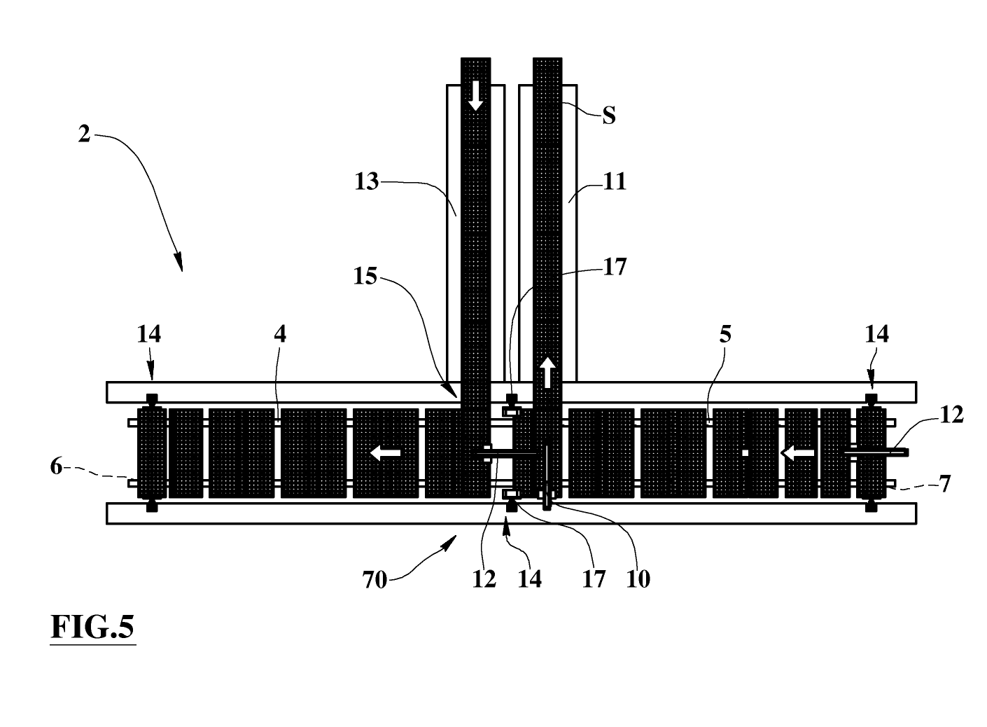

Making now reference also to FIG. 5, a possible plant configuration includes a conveyor 2 equipped with respective upper transport lines 4, 5 and at least one lower transport line 6, 7. The ends of the conveyor 2 are equipped with respective vertical transfer means 14.

The conveyor 2 is also provided with an intermediate module of bi-directional lateral exchange 70 associated to a first respective sliding plane or lateral conveyor 11 and to a second respective sliding plane or lateral conveyor 13. The vertical transfer means 14, associated at the right end of the conveyor of FIG. 5, is provided with a respective linear longitudinal actuator 12.

The intermediate module of bi-directional lateral exchange 70 of the plant of FIG. 5 includes a vertical transfer means 14 provided with a respective linear longitudinal actuator 12.

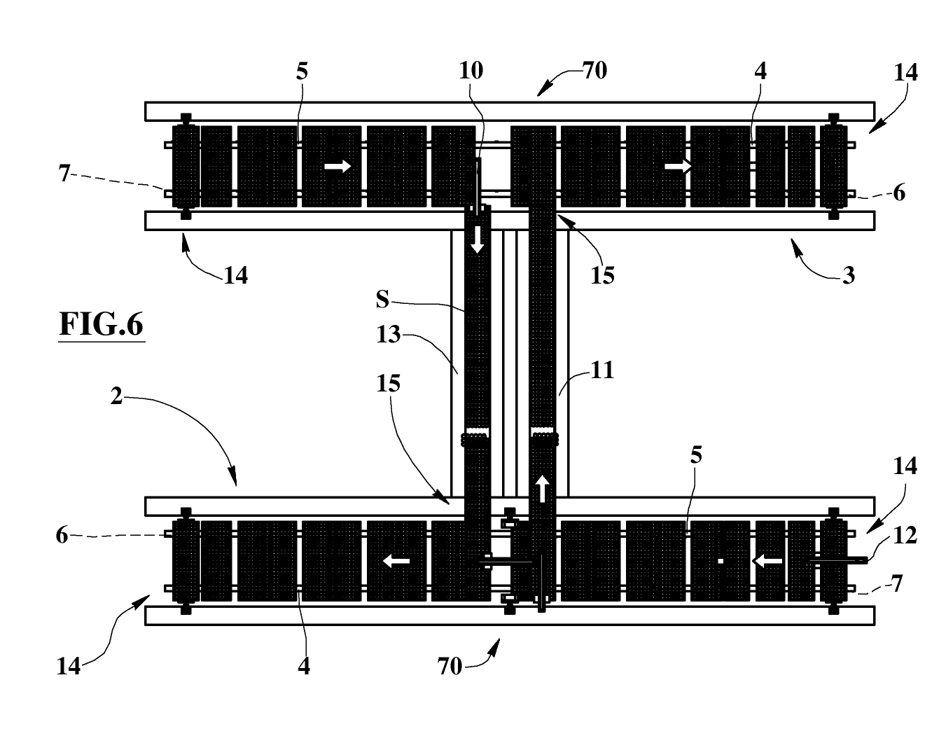

The plant configuration of FIG. 6 differs from the one of FIG. 5 because includes an additional conveyor 3 almost parallel to the other 2 and provided with a respective intermediate module of bi-directional lateral exchange 70 whose lateral entry sector 15 is fed by said second sliding plane or lateral conveyor 13 of the other conveyor 2 and whose first respective linear transverse actuator 10 supplies the first plane of sliding or lateral conveyor 11 of the other conveyor 2.

The ends and the intermediate module of bi-directional lateral exchange 70 of the additional conveyor 3 are provided with respective vertical transfer means 14 without linear longitudinal actuator 12.

The plant can be arranged or modified in an almost infinite number of configurations and its effectiveness allows to connect almost each ensemble of machines, stations, stores and similar with predetermined or variables ways by using simple operative drives or simple feeding of different elements.

An advantage of this invention is to supply a modular conveying plant which allows inserting additional workstations in a pre existing plant in a simple, fast and cheap way, without needing to displace or modify the pre-existing stations.

Another purpose is to allow a simple, fast and economic change of the product flow or path in a pre-existing plant.

1. Modular conveying plant for elements or containers, comprising at least one conveyor (2, 3), the at least one conveyor (2, 3) including respective upper transport lines (4, 5) separated in two portions by an interchangeable intermediate module (30, 50, 70), the intermediate module selected from the group consisting of a continuation intermediate module (30), an intermediate module of lateral deviation (50), and an intermediate module of bi-directional lateral exchange (70).

2. Plant according to claim 1 wherein the at least one conveyor (2, 3) is provided with respective lower transport lines (6, 7) parallel to and below the upper lines (4, 5).

3. Plant according to claim 1 wherein each continuation intermediate module (30) comprises at least one upper transport portion (8) coplanar and adjacent to ends of the upper transport lines (4, 5), and wherein when in an assembled condition, the continuation intermediate module (4) allows the element or container to pass from an upper transport line (4, 5) to another transport line (5, 4) of the conveyor (2, 3).

4. Plant according to claim 2 wherein each continuation intermediate module (30) further includes a transport lower portion coplanar and adjacent to ends of the lower transport lines (6, 7), and wherein when in an assembled condition, the continuation intermediate module (4) allows the elements or containers to pass from a lower transport line (6, 7) to another transport line (7, 6) of the conveyor (2, 3).

5. Plant according to claim 1 characterised in that each intermediate module of lateral deviation (50) comprises at least a first respective linear transverse actuator (10) fit to translate the elements or containers from one of the transport lines (4, 5) to a first respective sliding plane or lateral conveyor (11) orthogonally oriented with respect to the conveyor (2, 3) of the intermediate module of lateral deviation (50).

6. Plant according to claim 1 characterised in that each intermediate module of bi-directional lateral exchange (70) comprises at least a first respective linear transverse actuator (10) fit to translate the elements or containers from one of the transport lines (4, 5) to a first respective sliding plane or lateral conveyor (11) orthogonally oriented with respect to the conveyor (2, 3) of the intermediate module of bi-directional lateral exchange (70) which further comprises at least one lateral entry sector (15) supplied by a second respective sliding plane or lateral conveyor (13), parallel to the first (11) and fit for the element or container sliding or translation from said plane or lateral conveyor (13) to one of the transport lines (4, 5).

7. Plant according to claim 2 wherein at least one intermediate modules of lateral deviation (50) and of bi-directional lateral exchange (70) comprises at least a first respective linear transverse actuator (10) for the upper transport lines (4, 5) and/or at least an actuator (10) for the lower transport lines (6, 7); each transverse linear actuator (10) being associated to a first respective sliding plane or lateral conveyor (11) and that at least one bi-directional exchange lateral module (70) includes at least one lateral entry sector (15) supplied by a respective second sliding plane or lateral conveyor (13) for the upper transport lines (4, 5) and/or at least one lateral entry sector (15) for the lower transport lines (6, 7).

8. Plant according to claim 2 further comprising vertical transfer means (14) fit to translate the elements or containers from a lower transport line (6, 7) to an upper transport line (4, 5) of the same conveyor (2, 3) or vice-versa.

9. Plant according to claim 8 characterised in that each vertical transfer means (14) includes a vertical linear actuator (16) provided with a couple of shelf means (17) intended to match, from the bottom, with the lateral portions of the elements or containers.

10. Plant according to claim 9 characterised in that each vertical transfer means (14) includes a respective linear longitudinal actuator (12) associated to a destination upper transport line (4, 5), or a lower line (6, 7), to transfer elements or containers from the shelf means to said destination transport line (4, 5, 6, 7).

11. Plant according to claim 2 wherein at least one of the selected intermediate modules further comprises vertical transfer means (14).

12. Plant according to claim 5 wherein the conveyor (2) is provided with respective upper transport lines (4, 5) and at least a lower transport line (6, 7), having at least, at one end, a vertical transfer means (14) and is further provided with at least an intermediate module of bidirectional lateral exchange (70) associated to a first respective sliding plane or lateral conveyor (11) and to a second respective sliding plane or a lateral conveyor (13).

13. Plant according to claim 12 further comprising vertical transfer means (14) for each conveyor end, at least one vertical transfer means provided with a respective linear longitudinal actuator (12).

14. Plant according to claim 12 characterised in that at least one intermediate module of bidirectional lateral exchange (70) comprises vertical transfer means (14).

15. Plant according to claim 12 further comprising an additional conveyor (3) located almost parallel to the conveyor (2) and provided with a respective intermediate module of bidirectional lateral exchange (70) whose lateral entry sector (15) is fed by said second sliding plane or lateral conveyer (13) of the conveyor (2) and whose first respective linear transversal actuator (10) feeds the first sliding plane or first lateral conveyor (11) of the conveyor (2).

16. Plant according to claim 15 further comprising, between the ends and the intermediate module of bidirectional lateral exchange (70) of the additional conveyor (3), a vertical transfer means (14) with or without a respective linear longitudinal actuator (12).

17. Plant according to claim 3 wherein each continuation intermediate module (30) further includes a transport lower portion coplanar and adjacent to ends of the lower transport lines (6, 7), and wherein when in an assembled condition, the continuation intermediate module (4) allows the elements or containers to pass from a lower transport line (6, 7) to another transport line (7, 6) of the conveyor (2, 3).

18. Plant according to claim 5 wherein at least one intermediate modules of lateral deviation (50) and of bi-directional lateral exchange (70) comprises at least a first respective linear transverse actuator (10) for the upper transport lines (4, 5) and/or at least an actuator (10) for the lower transport lines (6, 7); each transverse linear actuator (10) being associated to a first respective sliding plane or lateral conveyor (11) and that at least one bi-directional exchange lateral module (70) includes at least one lateral entry sector (15) supplied by a respective second sliding plane or lateral conveyor (13) for the upper transport lines (4, 5) and/or at least one lateral entry sector (15) for the lower transport lines (6, 7).

19. Plant according to claim 6 wherein at least one intermediate modules of lateral deviation (50) and of bi-directional lateral exchange (70) comprises at least a first respective linear transverse actuator (10) for the upper transport lines (4, 5) and/or at least an actuator (10) for the lower transport lines (6, 7); each transverse linear actuator (10) being associated to a first respective sliding plane or lateral conveyor (11) and that at least one bi-directional exchange lateral module (70) includes at least one lateral entry sector (15) supplied by a respective second sliding plane or lateral conveyor (13) for the upper transport lines (4, 5) and/or at least one lateral entry sector (15) for the lower transport lines (6, 7).
